(19) United States
(12) Patent Application Publication
(10) Pub. No.: US 2010/0269470 A1
(43) Pub. Date: Oct. 28, 2010

(54) Optical Yield Monitor for a Sugar Cane Harvester

(76) Inventor: Randy R. Price, (US)

Correspondence Address: Randy Price, 147 Seaton Hall, Manhattan, KS, 66506, US

(21) Appl. No.: 12/429,694

(22) Filed: Apr. 24, 2009

(51) Int. Cl. A01D 41/127

(52) U.S. Cl. 56/10.2 H

(57) ABSTRACT

An optical sugar cane yield monitor that consist of a row of optical sensors mounted in the elevator floor of the harvester in such a way that when combined with the appropriate electronics, software, and connections, the system measures a duty-cycle type reading of billet depth on the slats that is related to the amount of sugar cane flow through the harvester. The sensors are inserted in the elevator floor in such a way that they run in the material flow and self-clean with the normal souring of the elevator floor.

### RELATED APPLICATIONS

The present application is related to U.S. Pat. No. 6,272,819, issued Aug. 14, 2001, for SUGAR CANE YIELD MONITOR, by Keith W. Wendte, Andrey Skotnikov, Kurian K. Thomas, included by reference herein.

The present application is related to U.S. Pat. No. 6,508,049, issued Jan. 21, 2003, for MASS FLOW RATE SENSOR FOR SUGAR CANE HARVESTER, by Graeme Justin Cox, David Richard Vivian Cox, Simon Rixson Zillman, Randolf Arthur Pax, Derk Machiel Bakker, Harry David Harris, included by reference herein.

The present application is related to U.S. Pat. No. 7,089,117, issued Aug. 8, 2006, for METHOD OF ESTIMATING CROP YIELDS, by Donald McEheny, Jr., included by reference herein.

The present application is related to U.S. Pat. No. 6,751,515, issued Jun. 15, 2004, for YIELD MAPPING, by Mark Ramon Moore, included by reference herein.

The present application is related to U.S. Pat. No. 6,616,527, issued Sep. 9, 2003, for YIELD MONITOR FOR FORAGE CROPS IN FORAGE MACHINERY INCLUDING AN, by Kevin J. Shinners, Neil G. Barnett, Walter M. Schlesser, included by reference herein.

The present application is related to U.S. Pat. No. 6,431,981, issued Aug. 13, 2002, for YIELD MONITOR FOR FORAGE CROPS, by Kevin J. Shinners, Neil G. Barnett, Walter M. Schlesser, included by reference herein.

The present application is related to U.S. Pat. No. 5,480,354, issued Jan. 2, 1996, for SMART CROP YIELD MONITOR, by Firooz A. Sadjadi, included by reference herein.

The present application is related to U.S. Pat. No. 5,779,541, issued Oct. 3, 1996, for COMBINE YIELD MONITOR, by Jim C. Helfrich, included by reference herein.

The present application is related to U.S. Pat. No. 2,561,763, issued Jun. 1, 1951, for MATERIAL FLOW INDICATOR, by Waters et al., included by reference herein.

The present application is related to U.S. Pat. No. 4,114,557, issued Oct. 28, 1976, for PARTICLE MONITORING SYSTEM, by Robert J. De Brey, included by reference herein.

The present application is related to U.S. Pat. No. 11/489,141, issued Jul. 19, 2006, for YIELD MONITOR, by William B. Jernigan, included by reference herein.

### FIELD OF THE INVENTION

The present invention relates to a yield monitor and, more particularly, to a yield monitor that operates on sugar cane billet harvester.

### BACKGROUND OF THE INVENTION

Sugar cane (Saccarum officinarum) is a long tern, multi-year crop grow in the South Central and Eastern parts of the United States and other countries. Currently sugar cane accounts for nearly 900,000 acres in the United States and over 5.3 million worldwide (FAOSTAT, 2001). Its primary use is for raw sugar, but some countries have completely offset their petroleum imports when converted to ethanol (which yields an 8:1 output to input ratio versus corn which has 1.2:1). Yields range anywhere from 20 to 60 tons/acre.

Sugar cane is harvested with a billet-type harvester. This harvester cuts long bamboo sugar cane stalks into 12 to 16 inch pieces called billets. Some countries harvest whole stalks, but highly mechanized areas use the billet-type harvester (since it greatly increases trailer bulk densities and reduces transportation cost). Currently, combine sales have under gone a massive increase and more than 1000 harvesters are expected to sale worldwide this year alone (Price, 2007).

Although widely accepted yield monitors are developed for other crops (small grains and cotton), a suitable yield monitor does not exist for sugar cane harvesters. If a yield monitor were available, the output could be used to show variability with-in or between fields, help schedule mill loads, indicate when a transportation truck is full, or determine when the field should be replanted. Johnson (2007) states that this is the number one requested device by farmers at field days and trade shows and most researchers agree that yield monitoring of sugar cane is a crucial building block in sugar cane precision farming activities (Erickson, B. 2006; Johnson and Richard. 2005; Jhoty and Autre, 2003).

### References

Benjamin, C. E., M. P. Mailander, and R. R. Price. 2001. Sugar Cane Yield Monitoring System. ASAE Paper No. 011189. St. Joseph, Mich.: ASABE.

Benjamin, C. E. 2002. Sugar cane yield monitoring system. MS Thesis. Baton Rouge, La.: Louisiana State University, Department of Biological and Agricultural Engineering.

Cerri, D. G. and P. G. Magalhães. 2005. Sugar Cane Yield Monitor. ASAE Paper No. 051154. St. Joseph, Mich.: ASABE.

Cerri, D. G. and P. G. Magalhães. 2003. Applying Sugar Cane Precision Agriculture in Brazil. ASAE Paper No. 031041. St. Joseph, Mich.: ASABE.

Cox G., Harris H, Pax R and Dick R. 1996. Monitoring cane yield by measuring mass flow rate through the harvester. p. 152-157. Proc. of Aust. Soc. of Sugar Cane Technologists.

Cox, G. J., D. R. Cox, S. R. Zillman, R. Simon, R. A. Pax, D. M. Bakker, M. Derk, and H. D. Harris. 2003. Mass Flow Rate Sensor for Sugar Cane Harvester. U.S. Pat. No. 6,508,049.

Cox, G. J., H. D. Harris, D. R. Cox, D. M. Bakker, R. A. Pax, and S. R. Zillman. 1999. Mass Flow Rate Sensor for Sugar Cane Harvesters. Australian Patent No. 744047.

Erickson, B. 2006. Precision Agriculture in Colombian Sugar Cane. Site Specific Management Center Newsletter. Purdue University. September Issue.

FAOSTAT, 2001. Food and Agricultural Organization of the United Nations. Crop Statistics Data Base.

Jaisaben Enterprises. 2006. Jaisaben Enterprises and AgGuide Pty Ltd Join Forces to Develop Exciting Yield Monitor. Available at http: www.jaisaben.com. Accessed 11 Dec. 2006.

Jhoty, I, and J C Autre. 2003. Precision Agriculture—Perspectives for the Mauritian Sugar Industry. Mauritius Sugar Industry Research Institute. Proceedings. ISSCT Agronomy Workshop.

Juniper Systems Inc. 2007. http://www.junipersys.com/products/products.cfm?id=42.

Johnson, R. 2007. Personal communication. Sugar Cane Research Station. USDA. Houma, La.

Johnson, R. M. and Richard Jr., E. P. 2005. Precision Agriculture Research in Louisiana Sugarcane. Sugar Journal. 67(11):6-7.

Louveia, Kodi. 2003. Personal communication. Ouachita Fertilizer. New Iberia, La.

Molin, J. P. and L. A. Menegatti. 2004. Field-testing of a sugar cane yield monitor in Brazil. ASAE Meeting Paper No. 041099. St. Joseph, Mich.: ASABE.

Moody, F. H., J. B. Wilkerson, W. E. Hart, J. E. Goodwin, and P. A. Funk. 2000. Non-intrusive flow rate sensor for harvester and gin application. In Proc. Belt wide Cotton Conf., 410-415. Memphis, Tenn.: Nat. Cotton Council Am.

Pagnano, N. B., and P. S. Magalhães. 2001. Sugarcane yield measurement. p. 839-3. In: BLACKMORE, S. and GRENIER, G. (ed.) 3rd European Conference on Precision Agriculture, Jun. 18-20, 2001. Montpellier: AgroMontpellier-ENITAdeBordeaux,.

Price, R. R., A. Peters, and J. Larson. 2006. Testing of Yield Monitors for Sugar Cane Harvesters. Internal Paper: United States Sugar Corporation.

Price, R. R. 2007. Personal communication. Banner Engineering Salesman. Shreveport, La.

Thomasson, A. J., and R. Sui. 2004. Optical Peanut Yield Monitor: Development and Testing. ASABE Presentation Paper No. 041095. St. Joseph, Mich.: ASABE.

Thomasson, J. A., D. A. Pennington, H. C. Pringle, E. P. Columbus, S. J. Thomson, and R. K. Byler. 1999. Cotton mass flow measurement: experiments with two optical devices. App. Eng. in Agric. 15(1): 11-17.

Thomasson, J. A., R. Sui, G. C. Wright, and A. J. Robson. 2006. Optical Peanut Yield Monitor: Development and Testing. App. Eng. in Agric. Vol. 22(5): 809-818

Thomasson, J. A., and R. Sui. 2000. Advanced optical cotton yield monitor. In: Proc. Belt wide Cotton Conf., eds. P. Dugger and D. Richter, 408-410. Memphis, Tenn.: Nat. Cotton Council Am.

Wendte, K. W., A. Skotnikov, and K. K. Thomas. 2001. Sugar Cane Yield Monitor. U.S. Pat. No. 6,272,819.

Wilkerson, J. B., F. H. Moody, W. E. Hart, and P. A. Funk. 2001. Design and evaluation of a cotton flow rate sensor. Trans. of the ASAE 44(6): 1415-1420.

Wilkerson, J. B., F. H. Moody, and W. E. Hart. 2002. Implementation and field evaluation of a cotton yield monitor. App. Eng. in Agric. 18(2): 153-159.

Some yield monitors for sugar cane exist in patents and literature. These are discussed as follows:

Cox et al. (1996a) discusses the use of hydraulic pressure and angular speed sensors to determine the sugar cane flow rate. These sensors were mounted on the chopper and elevator motors and produced a linear line output with a correlation coefficient of 0.96 for the chopper motor and 0.95 for the elevator motor. The systems were used to map several fields and indicated typical yield variances very well with errors around 10%. Still, several problems existed with the system. It was thought that the calibration equation would change as the snapping bars on the chopper drum wore, which occurs very fast on harvesters, and as plant maturity, moisture content, and varieties changed. It was also thought that inconsistent readings would occur during the starting and stopping the machine which happen frequently in sugar cane harvesting while the combine is waiting for wagons to load.

Cox et al. (2003—U.S. Pat. No. 6,508,049) also list a device that uses a weigh scale mounted in the upper portion of the elevator floor to measure the mass flow rate of material. The patent itself doesn't list any research results (only a single calibration chart) but does list all the components used in the system. These components consist of a weigh scale plate, attachment structure, error correction system, anti-friction pad, air flow dampener (to negate the suction created by the overhead secondary fan), an inductive sensor (or other means to detect passing slats), and a block diagram of all the steps necessary to create a working monitor system.

Several other researchers have investigated weigh scales similar to Cox's design. These are Pagnano and Magalhães (2001), Benjamin et al. (2001, 2002), Cerri and Magalhães (2005, 2003), and Molin and Menegatti (2004).

Pagnano and Magalhães (2001) tested a weigh scale in Brazil that was outfitted with accelerometers and a Butterworth low pass filter system to help reduce noisy in the signals and provide a better calibration. They report errors ranging from 0.35 to 4.02% in laboratory tests with an average error of 2.5% in one field, and errors that ranged from 0.38 to 28.66% in other fields. The range of errors was thought to be caused by the starting and stopping of the machine while waiting on a wagon.

Benjamin et al. (2001, 2002) tested a weigh scale in Louisiana without any support systems (accelerometers, filtering, tilt angle, etc.). Her system produced a linear calibration line with a 0.90 slope and a correlation coefficient of 0.966. Average errors for harvested rows were 11.05%. A statistical analysis on the system indicated that different cane varieties had an effect on the readings, but that maturity of cane, section length, and the flow rate did not have an effect. The system also exhibited a problem with the weight scale plate itself in that it mud, dirt, and grim would form a bridge between the weight plate and the elevator floor (causing periodic cleaning problems and non-operation of the weight scale over long periods of time).

Cerri and Magalhães (2005, 2003), and Molin and Menegatti (2004), tested a weigh scale with better filtering techniques than that of Pagnano and Magalhães (2001), and posted very good results with an average percent error of about 4%. Still, the unit was only tested in dry conditions and criticisms in the U.S. were that the weight scale plate itself might exhibit the “silting-in” problems as in Benjamin's.

Another patented yield monitor for sugar cane Wendte et al. (2001—U.S. Pat. No. 6,272,819). This monitor uses a torsion deflection plate at the outlet of the elevator (similar to the force impingement plates used in most small grain yield monitors) to determine sugar cane flow as they spill from the elevator outlet. This monitor also included a base cutter pressure sensor to aid in the prediction capabilities. To date, this unit has not shown up on the marketplace and is not commonly sold.

Another monitor cited as possibly working in sugar cane, but never tested in this application, is a monitor by Thomasson and Sui (2004). This sensor uses an optical sensor bolted onto the side of a peanut harvester's blower tube to determine flow. Correlation coefficients for the system were good at 90%. Still, the system was never tested on a sugar cane harvester and would have the same problems as other sugar cane monitors—the mud and debris clogging problems. Also, a blower tube as such does not exist on the sugar cane harvester. Other research in this area are given by Thomasson et al. (2006, 1999), Wilkerson et al. (2001, 2002), Moody et al. (2000), and Thomasson and Sui (2000).

Several sugar cane monitors exist on the Internet but have not been verified by independent research. These monitors are the Harvestmaster® by Juniper Systems, Inc., (Utah) and a unit by Jaisaben (2006) and AgGuide Pty Ltd.

The Harvestmaster® (Juniper Systems Inc., 2007) is sold in the U.S. for potato harvesting, but a few units were advertised and sold for use on sugar cane harvesters (although these units have been discontinued for this purpose). These monitors used an over-head ultrasonic sensor set mounted over the outlet conveyer to sense the volume of sugar cane on each slat. It is not know what type of processing algorithm they used. Most people who have tested the system (Johnson, personal communication 2007, Price et al., personal communication 2006, and Louveia, personal communication 2003) indicate that the system worked great, with a less than 100 lbs deviation on an 8 ton weight (which gives an astonishing 0.6% error), but the units would lose calibration quickly and drift. It is not known why this problem occurred. Possible reasons are that the sensors became dirty, air and temperature affects, or changes in the material properties.

Another monitor mentioned on the Internet for sugar cane (but not giving the operating principle or method) is a website listing by Jaisaben (2006) and AgGuide Pty Ltd. This website does provide a graph (showing a linear line with a correlation coefficient of 0.90 and errors ranging ±5%) and a field map made by the monitor, but does not indicate the actual operating principle.

Even though patented and researched methods exist, none are currently sold and available to farmers. Reasons for this are that 1) current methods are not robust enough to survive the harsh harvesting environment, 2) most monitors are too hard to install on individual machines and require extensive modifications, 3) they do not hold calibrations well, and 4) none have yet satisfied marketing factors enough to become saleable units.

When evaluating the systems for individual shortcomings, the following can be stated for each one:

1) The pressure monitoring system (Cox et al. 1996a) has both short and long term calibration problems (since the cutting bars wear quickly and the elevator slats become bent over time and have high frictional changes throughout their life span).

2) The force plate (Wendte et a.l, 2001) may also exhibit similar problems since elevator tilt can vary and different sugar cane varieties with different size stalks and density would affect the readings (although the base cutter pressure sensor may offset this problem).

3) The Harvestmaster® system, although working great at times, looses calibration quickly and has not yet proven to be useable over long periods of time.

4) Weigh scales have good error rates (4% to 12%), and measure everything that goes over the elevator (which is great in Louisiana where you want to determining truck load out weights), but they have the disadvantages of 1) a rather large hole is needed in the elevator to mount the plate (which makes the system not very easy to adapt to a machine already sold and in the field), 2), many sensors are needed to properly evaluate the sensor readings (leading to failures and high cost of the system), and 3) the weigh plate itself may be prone to “silting-in” or sticking (caused by the dirt, debris, and sticky sugary solution emitted by the billets and carried over the plate).

5) Optical sensors, although sufficiently developed for other crops, have not been developed for the sugar cane industry. Major problems with these sensors are keeping the optics clean in the dirty and harsh sugar cane harvesting environment, finding a place where they can function properly, and developing an appropriate method and algorithm to evaluate the sugar cane flow.

It is therefore an object of the invention to measure yield and field variances in sugar cane fields.

It is another object of the invention to perform this measurement using an optical approach.

It is another object of the invention to provide method that is both simple and easy to install on harvesters that are in the field.

It is another object of the invention to self-clean with the material flow in the elevator and not need any maintenance.

It is another object of the invention to not need an elevator chain speed speed sensor and thus minimize the electrical components of the system.

### SUMMARY OF THE INVENTION

In accordance with the present invention, there is provided an optical sugar cane yield monitor that consist of a row of sensors mounted in the floor of the elevator in such a way that when combined with the appropriate electronics and software, measures a duty-cycle type reading of billets on the slats which is related to sugar cane flow through the harvester and yield (when combined with time and width of cut). The sensors are mounted flush with the floor of the elevator in such a way that they look up into the billet flow, and this mounting causes the faces of the sensors run in the material flow and self-clean with the natural scouring that occurs in the elevator floor. The sensors can run the life of the floor without any maintenance and automatically unclog if they become clogged. The volume measurement of the sugar cane billets is fairly consistent with the depth of billets since the elevator runs at a fairly step angle (55 degrees during loading), slat speeds are high (72 inches per second which stacks the billets tight against the slats), and the material loading per slat is low (except in very high yielding cane).

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of the yield monitor system on a sugar cane havester;

FIG. 2 is a detail view of the elevator and sensor system;

FIG. 3 is a detail view of the flow chart used for billet detection and duty cycle determination;

FIG. 4 is a section view of the sensors mounted in the elevator floor;

FIG. 5 is a detail view of a calibration line for yield monitor system; and

FIG. 6 is a plan view of an optical yield monitor system.

For purposes of clarity and brevity, like elements and components will bear the same designations and numbering throughout the Figures.

### DESCRIPTION OF THE PREFERRED EMBODIMENT

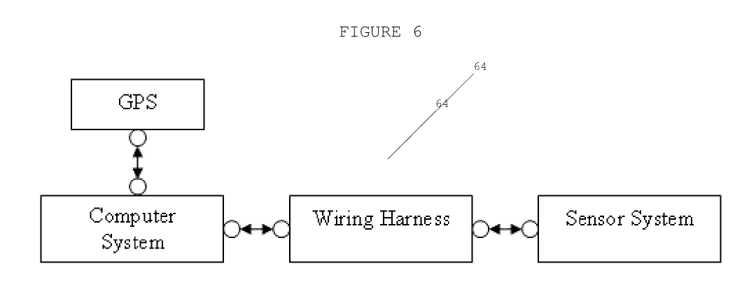

FIG. 6 is a plan view of the optical yield monitor system 64.

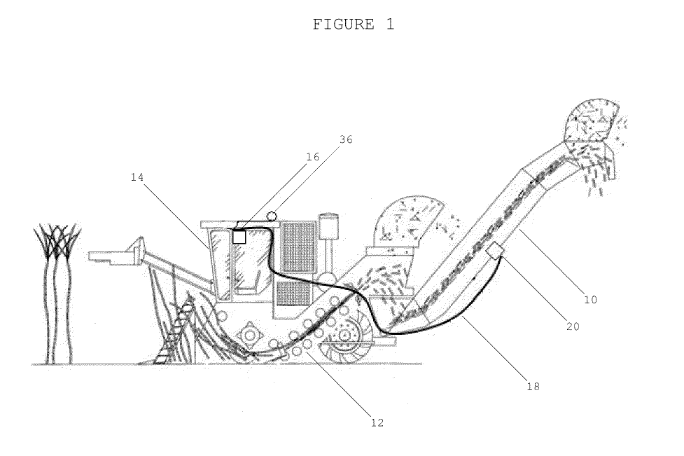

FIG. 1 is a perspective view of the optical yield monitor system 64 mounted on a sugar cane harvester 12 comprising of a computer system 16, wiring harness 18, and a sensor system 20. The computer system 16 consist of all the necessary components to receive signals from the sensor system 20, compute a duty-cycle 34 type calculation, read location, time, and speed from a gps 36 unit (that is either built into the computer system 16 or mounted externally), and display and store results. The computer system 16 is usually mounted in the cab 14 of the harvester 12 but can be mounted elsewhere, such as on the elevator 10 for data logging purposes. The Sensor system 20 consist of all the components necessary to detect and sense the Volume of billets 22 on the Slats 24 and the open space 62. The Sensor system 20 is mounted on the underneath of the elevator 10 in the middle section of the elevator 10 (which has the most angle during loading). Location and mounting of the Sensor system 20 is not critical but should be high enough up the elevator 10 to allow the Volume of billets 22 to settle on the Slats 24 (which is done fairly quickly because of the high speed and angle of the elevator 10). Approximately one third to half way up has shown to be adequate, although any position in the elevator 10 will work with varying results. The high angle of the elevator 10 also causes the Volume of billets 22 to form a nice triangular volumes on the Slats 24 and the volume of material can be measured with only a depth reading of the volume of billets 22 from the elevator 10 Floor 26. The Wiring harness 18 allows the computer system 16 and Sensor system 20 to communicate and provides power to the Sensor system 20. The Wiring harness 18 is composed of standard electrical wires, but could be composed of optical or wireless transmission components (although power would have to be sent to the Sensor system 20 through an alternate means such as solar, self-generation methods, battery, or alternate power terminals on the harvester 12).

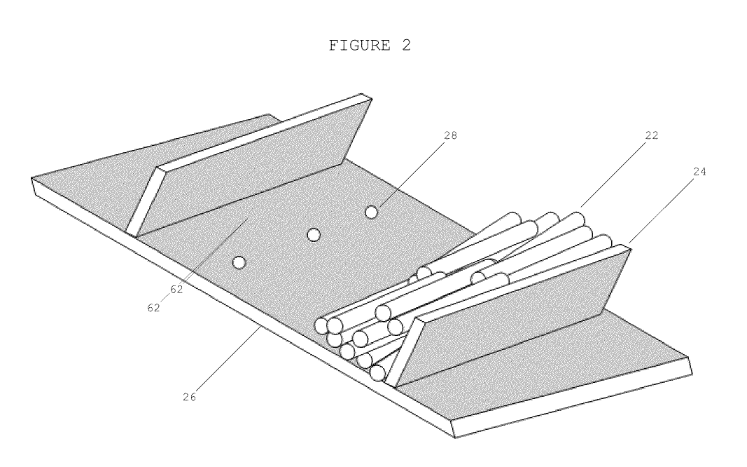

FIG. 2 is a detail view of the elevator 10 and sensor system 20 showing placement of the sensors 28, which are mounted in a row perpendicular to the volume of billet flow on the slats 24 (so that as the slats 24 and volume of billets 22 pass over them, they measure the depth of the volume of billets 22 and the open space 62 between the slats 24 (using a simple on/off procedure). The current system uses three sensors 28, but any number could be used (one, two, three, five, ten, etc.). Also, if the sensors 28 were placed in a three dimensional pattern, other billet parameters such as spacing, speed, etc., could be determined. The sensors 28 are mounted in the floor 26 so that the face of the sensors 28 run in the material flow which cleans the face of the sensors 28 through the normal scouring of the elevator 10 floor 26. This causes the sensors 28 to have self-cleaning properties and the system needs no maintenance and can unclog itself if clogging occurs. The current system uses optical sensors 28 which emit a light source that reflects from the volume of billets 22 but any type of presence sensor 58 (gamma ray, inductive, capacitive, radio frequency, etc.) could be used.

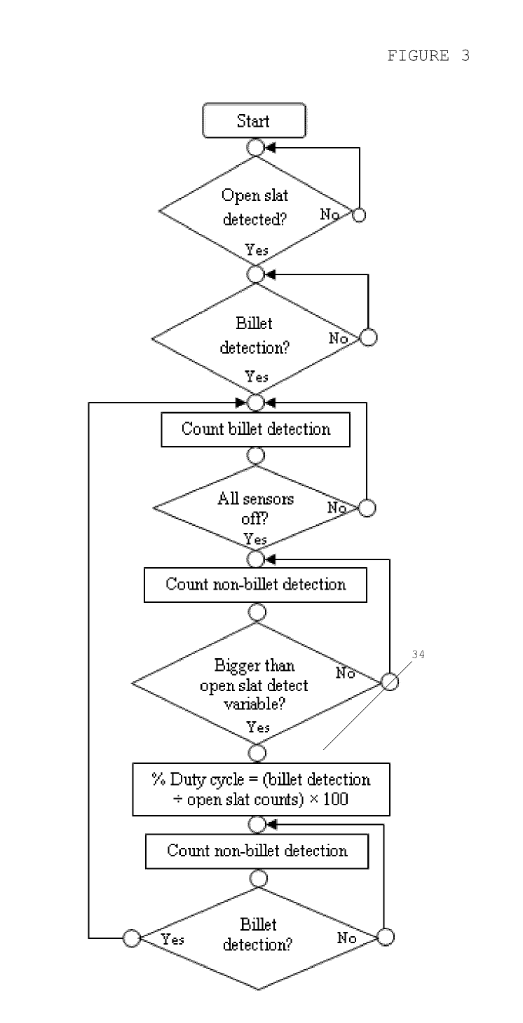

FIG. 3 is a detail view of a flow chart showing how the computer system 16 determines the depth of billets on the slat 56, open space 62, and the duty-cycle 34 calculation. The depth of billets and the open space 62 are determined by counting the number of loops through an algorithm cycle while detecting each feature (or could be done by computer timing).

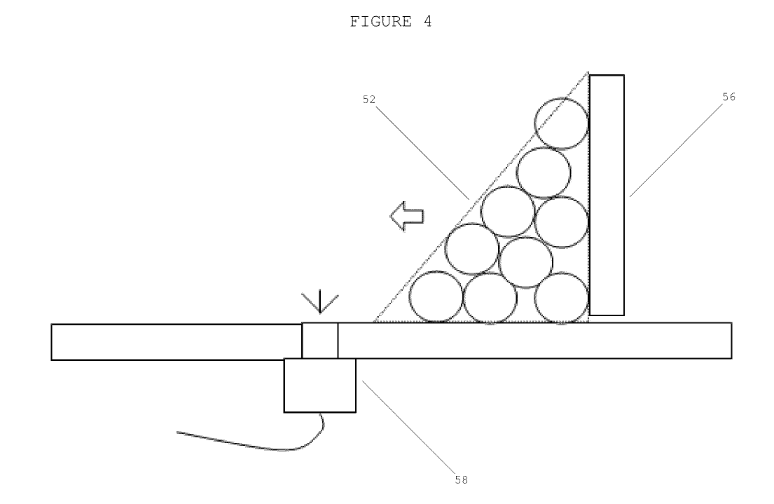

FIG. 4 is a right sectional view of the elevator 10 floor 26 showing the placement of the sensor 58 with it's lens flush with the inside of the elevator 10 floor 26 and the triangular area 52 made by the volume of billets 22 on the slat 56.

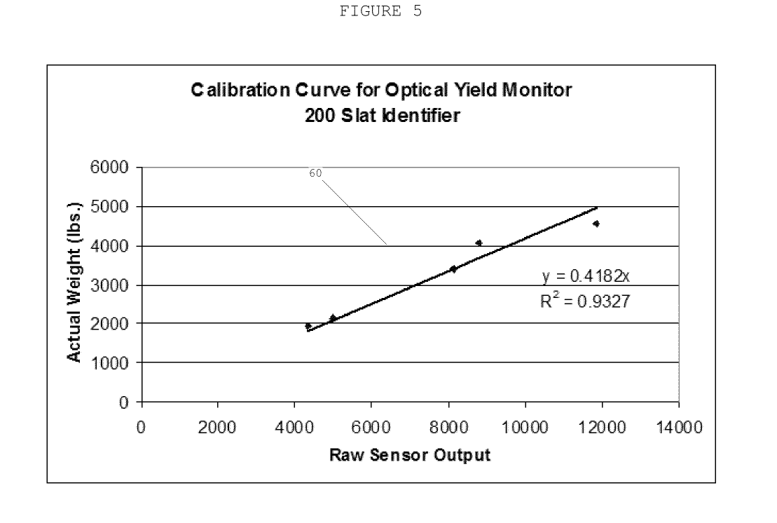

FIG. 5 is a detail view of the calibration line 60 achieved by the yield monitor system while harvesting and shows how the raw duty-cycle 34 numbers can relate to weight (lbs, tons, etc.) of sugar cane on the slats 24. When this information is combined with harvester 12 speed and cutting width, yield (tons/acre, kg/hectare, etc.) can be determined.

Obviously, the same procedures and methods described here could be used to evaluate the flow of materials in other elevators, conveyers, materials, and situations using the same principles.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An optical yield monitor for a sugar cane harvester for determining the variances in a sugar cane field and harvested output, comprising:
means for transforming the sensor readings into useable data and displaying and/or storing the results;
means for detecting billets on the slats;
means for detecting the billet depth on the slats;
means for determining the amount of billets per slat, functionally embedded to said means for transforming the sensor readings into useable data and displaying and/or storing the results; and
means for self-cleaning in the material flow and automatic unclogging.

2. The optical yield monitor for a sugar cane harvester in accordance with claim 1, wherein said means for transforming the sensor readings into useable data and displaying and/or storing the results comprises an electronic, screen, gps, storage computer system.

3. The optical yield monitor for a sugar cane harvester in accordance with claim 1, wherein said means for detecting billets on the slats comprises an optical sensor system.

4. The optical yield monitor for a sugar cane harvester in accordance with claim 1, wherein said means for detecting the billet depth on the slats comprises an optical, row, multiple sensors.

5. The optical yield monitor for a sugar cane harvester in accordance with claim 1, wherein said means for determining the amount of billets per slat comprises a calculation duty-cycle.

6. The optical yield monitor for a sugar cane harvester in accordance with claim 1, wherein said means for self-cleaning in the material flow and automatic unclogging comprises a flush sensor.

7. An optical yield monitor for a sugar cane harvester for determining the variances in a sugar cane field and harvested output, comprising:
an electronic, screen, gps, storage computer system, for transforming the sensor readings into useable data and displaying and/or storing the results;
an optical sensor system, for detecting billets on the slats;
an optical, row, multiple sensors, for detecting the billet depth on the slats;
a calculation duty-cycle, for determining the amount of billets per slat, functionally embedded to said computer system; and
a flush sensor, for self-cleaning in the material flow and automatic unclogging.

8. The optical yield monitor for a sugar cane harvester as recited in claim 7, wherein said sensor system has characteristics selected from the following group: electric, and multiple.

9. The optical yield monitor for a sugar cane harvester as recited in claim 7, wherein said sensors is electric.

10. The optical yield monitor for a sugar cane harvester as recited in claim 8, wherein said sensors is electric.

11. The optical yield monitor for a sugar cane harvester as recited in claim 7, wherein said sensor has characteristics selected from the following group: optical, and electrical.

12. An optical yield monitor for a sugar cane harvester for determining the variances in a sugar cane field and harvested output, comprising:
an electronic, screen, gps, storage computer system, for transforming the sensor readings into useable data and displaying and/or storing the results;
an optical, electric, multiple sensor system, for detecting billets on the slats;
an optical, row, multiple, electric sensors, for detecting the billet depth on the slats;
a calculation duty-cycle, for determining the amount of billets per slat, functionally embedded to said computer system; and
a flush, optical, electrical sensor, for self-cleaning in the material flow and automatic unclogging.
